(19) United States
(12) Patent Application Publication
(10) Pub. No.: US 2003/0147258 A1
(43) Pub. Date: Aug. 7, 2003

(54) Curing light with plurality of LEDs and corrresponding lenses configured to focus light

(76) Inventors: Dan E. Fischer, Sandy, UT (US); Bruce S. McLean, Sandy, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/068,397

(22) Filed: Feb. 5, 2002

(51) Int. Cl. F21V 5/00

(52) U.S. Cl. 362/573

(57) ABSTRACT

A light curing device includes a light source disposed at a distal end and a focusing means configured to focus light emitted from the light source. The light source is an LED light source and may include any quantity of LEDs. The focusing means includes lenses configured to collimate the light emitted from the light source. Hemispheric lenses are concentrically aligned with the individual LEDs in one embodiment. Aspheric lenses are concentrically misaligned with the individual LEDs in another embodiment. The LEDs can also be offset by particular angles and distances to channel the light into a desired path of illumination with a desired footprint.

### BACKGROUND OF THE INVENTION

1. The Field of the Invention

The present invention is generally with the field of light-curing devices and, more specifically, in the field of handheld dental light-curing devices incorporating LED light sources.

2. The Relevant Technology

In the field of dentistry, dental cavities are often filled and/or sealed with photosensitive compounds that are cured when they are exposed to radiant energy, such as visible light. These compounds, commonly referred to as light-curable compounds, are placed within dental cavity preparations or onto dental surfaces where they are subsequently irradiated by a light-curing dental device.

Many light-curing devices are configured with a fiber optic light guide for directing light from a light source into a patient's mouth. The light source may comprise, for example, a lamp, a halogen bulb or a light-emitting diode (LED). One end of the light guide is placed close to the light source so that the light emitted from the light source will be directed into the light guide. One problem with light guides, however, is that they are generally unable to capture all of the light that is generated by the light source, particularly the light that is emitted from LEDs, which may be emitted at angles of up to about 140°.

Another problem with light-curing devices incorporating light guides is that the light guides increase the weight of the light-curing device. This is particularly true when the light guide is composed of a heavy material composition, such as glass. The weight of the light-curing devices is a problem because it can make the light-curing device more difficult to use and manipulate within the operator's hand. Weight can also increase the cost of shipping and hence the overall cost of the device.

One method for overcoming the aforementioned limitations of existing light-curing devices incorporating light guides and for generally improving the efficiency of the light-curing devices is to place the light source, such as an LED, directly at the tip of the light-curing device so that a light-guide is no longer needed. This design is also useful because it enables the majority of the light emitted by the LED to be directed within the patient's mouth. One problem with this design, however, is that LEDs typically emit light at a wide angle, as mentioned above. Therefore, such existing devices are generally unable to channel the light into a desired path of illumination, or footprint, because of the significant angle at which the light is dispersed. Consequently, the light emitted from the LED is generally not focused into a desired path of illumination, thereby limiting the efficiency of the designs in which LEDs are disposed at the end of the light-curing devices.

Accordingly, in view of the foregoing, there is currently a need in the art for improved dental light-curing devices incorporating LEDs and, more particularly, to dental light-curing devices that are configured to focus or channel light emitted from a plurality of LEDs into a desired footprint or path of illumination.

### SUMMARY OF PRESENTLY PREFERRED EMBODIMENTS

Briefly summarized, presently preferred embodiments of the present invention are directed to improved dental devices configured for curing light-curable compounds. More particularly, the presently preferred embodiments of the present invention are directed to dental light-curing devices configured to emit light into collimated paths of illumination having desired footprints.

According to one presently preferred embodiment, the dental devices comprise a body extending between a proximal end and a distal end, a light source and a focusing means. The light source and the focusing means are preferably disposed at the distal end of the body and are sized and configured so as to be easily positioned within the mouth of a patient. The light source emits light from the dental device for predetermined durations when controls on the dental device are manipulated. The light source may include, among other things, a plurality of LEDs, an LED array, or a plurality of LED arrays.

The focusing means is configured to focus the light emitted from the light source into a desired path of illumination having a desired footprint with minimal dispersion. According to one embodiment, the focusing means comprises a lens or a plurality of lenses configured to refract the light emitted from the light source into the desired path of illumination. The lenses may include, for example, hemispheric lenses concentrically aligned with the individual LED light sources and aspheric lenses concentrically misaligned with the individual LED light sources. The lenses may also be integrally connected into a single lens having hemispheric or aspheric properties. According to the invention, the lenses are configured to be either fixedly connected with or detachable from the dental device.

According to one alternative embodiment, the focusing means comprises a particular configuration in which the LEDs of the light source are offset from one other by particular angles and distances. By offsetting the LEDs by particular angles and distances, it is possible to collimate the light emitted from the LEDs into the desired path of illumination with or without a lens.

According to one embodiment, the desired path of illumination is generally columnar, exhibiting minimal dispersion. The cross-sectional shape of the path of illumination, or the footprint, may include various shapes depending on the quantity and arrangement of LEDs that comprise the light source. According to one embodiment the desired footprint is generally elliptical, having the dimensions of between about 2 mm and 16 mm in length and between about 3 mm and 18 mm in width. In one preferred embodiment the elliptical footprint has the dimensions of between 8 mm and 14 mm in width and between 10 mm and 16 mm in length. The generally columnar quality exhibited by the path of illumination causes the elliptical footprint to occur at distances between 5 mm and 8 mm away from the light source. The elliptical footprint, or shape of the collimated light better bounds the surfaces of a substantial number of teeth with a patient's mouth, including the occlusal surfaces of the patient's molars and the lingual surfaces of the incisors, compared to, e.g., a circular footprint.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a bottom perspective view of one embodiment of the dental device of the invention that includes a body extending from a proximal end to a distal end with a light source and a focusing means disposed at the distal end of the dental device;

FIG. 2 illustrates a top perspective view of the dental device shown in FIG. 1 and further illustrates controls disposed on the body that can be used to activate the light source;

FIG. 3 illustrates a top perspective view of a single lens configured in shape and size to direct light emitted from a dual LED light source into a desired path of illumination;

FIG. 4 illustrates a cross-sectional side view of one embodiment of a dual LED light source and of a focusing means that includes two hemispheric lenses concentrically aligned with the LEDs of the light source;

FIG. 5 illustrates a cross-sectional side view of one embodiment of a dual LED light source and of a focusing means that includes two aspheric lenses concentrically misaligned with the LEDs of the light source;

FIG. 6 illustrates a cross-sectional side view of one embodiment of the light source in which two LEDs are offset by particular angles and distances to direct light emitted from the light source into a desired path of illumination; and

FIG. 7 illustrates one embodiment of the dental device of the invention in which the light source is emitting light into a path of illumination having a desired elliptical footprint.

### DETAILED DESCRIPTION OF THE PREFERRED EMBODIMENTS

A detailed description of the dental device of the invention will now be provided with specific reference to figures illustrating preferred embodiments of the invention. It will be appreciated that like structures will be provided with like reference designations.

The term “footprint,” as used herein, is generally made with reference to the cross-sectional shape of the path of illumination of light emitted from a light source. The dimensions of the footprint will typically vary according to the distance of the footprint from the light source and the angle at which the light is emitted by the light source. The general shape and dimensions of a footprint can generally be identified by placing a flat object in front of a light source and observing the area illuminated by the light source. As described herein, the dental devices of the present invention are configured to focus or collimate light emitted from an LED light source into a path of illumination having a desired footprint. As described below in more detail, the footprint also refers to the area in which light from a plurality of LEDs overlap.

The term “LED light source” includes any light-emitting diode (LED) or LED array. “LED” and “LED array,” which are sometimes used interchangeably herein, include the electrical components of the LED as well as the integral lens or micro lens of the typical LED structure. Accordingly, references made herein to embodiments of dental devices incorporating lenses are made with reference to secondary lenses or lenses that are not otherwise included as part of the LED structure.

The term “focusing,” as used herein, is generally used in reference to focusing means for collimating light and is defined as redirecting light emitted from a light source into a path of illumination having an angle of dispersion that is less than the angle in which the light was originally emitted from the light source, but which does not focus the light to a discrete focal point. In other words, focusing means for focusing or collimating light provides a collimating effect on the light emitted from the light source. “Focusing” is also generally defined as means for creating a desired footprint that is defined by the overlapping portions of light emitted from each component of the light source. For instance, when the light source comprises two or more LEDs, focusing the light emitted from the light source comprises the act of directing at least a portion of the light emitted from each LED into a desired footprint, where the light from each LED overlaps. Accordingly, focusing means for focusing the light may comprise the particular configurations in which the LEDs are spatially and angularly offset from one another for causing the light emitted from each of the LEDs to overlap within a desired footprint. According to this application, focusing means does not include reflectors configured to collimate the light or to reflect the light into a desired footprint. According to the invention, focusing means also does not include the integral lens of the LED through which light is emitted.

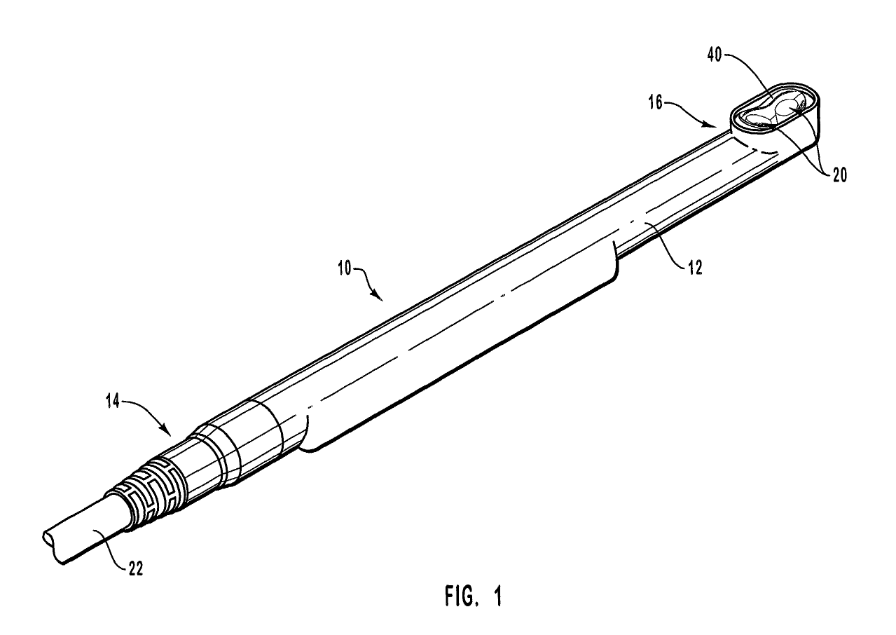

Reference is first made to FIG. 1, which illustrates a bottom perspective view of one embodiment of the dental device 10 of the invention. As shown, the body 12 of the dental device 10 extends from a proximal end 14 to a distal end 16. Although the body 12 is shown to be sleek and slender, it will be appreciated that the body 12 of the dental device 10 may comprise any desired shape and size.

A light source 20 disposed at the distal end 16 of the dental device 10 is configured to emit light suitable for curing light-curable compounds, such as, for example, during dental restoration procedures. The light source 20, as shown, includes a plurality of LEDs. Although only two LEDs are shown, it will be appreciated that the light source 20 may also include more than two LEDs. The light source 20 may also include an LED array, a plurality of LED arrays, and any combination of LEDs and LED arrays. An example of a dental device incorporating a light source comprising LED arrays is disclosed in U.S. Pat. No. 6,331,111, issued to Cao, which is incorporated herein by reference.

According to the preferred embodiment of the invention, the light source 20 and the distal end 16 of the body 12 are sized and configured so as to be easily inserted into the mouth of a patient, thereby enabling light generated by the light source 20 to be directly emitted into the patients mouth without first passing through an elongated light guide, as required by many conventional light curing devices.

According to the present embodiment, the light source 20 is powered by a remote electrical power supply (not shown), which may include, but is not limited to, the power outlet of a wall receptacle, a battery, a generator, a transformer or any other source capable of supplying power to the dental device. A power cord 22 connected at the proximal end 14 of the dental device 10 operably interconnects the remote power supply with the dental device 10.

According to one alternative embodiment, not shown, the proximal end 14 of the dental device is not connected to a power cord 22, but rather the dental device 10 is equipped with an integral battery pack that is capable of powering the dental device 10 and energizing the light source.

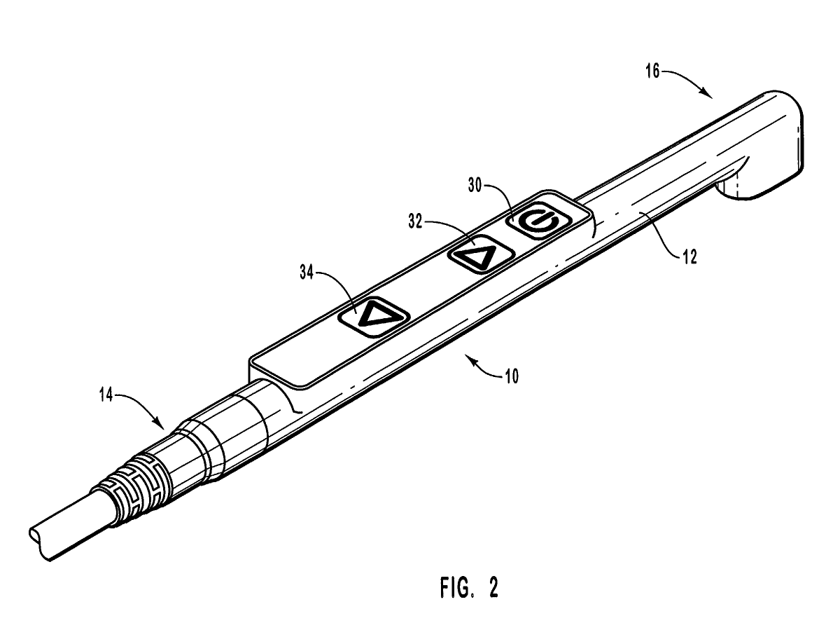

FIG. 2 illustrates a top perspective view of the dental device 10 shown in FIG. 1 and further illustrates controls that are disposed on the body 12 of the dental device 10. According to this embodiment, the controls are configured to enable a dental practitioner to control the activation of the light source 20. According to this embodiment, the controls preferably include three different buttons 30, 32, 34. The first button 30, when depressed, activates the light source 20 for a predetermined duration of time, such as, for example, 15 seconds, thereby enabling the dental practitioner to use the dental device 10 without having to continuously depress button 30 during use. The second and third buttons 32, 34 may be used to increase or decrease the predetermined duration of time by a desired increment of time, such as, for example, by 5 second increments. The controls are advantageously ergonomically mounted on the body 12 of the dental device 10 for ease of use. In particular, the controls are advantageously disposed on the body 12 in a manner which enables them to be manipulated by the thumb or finger of the dental practitioner. It will be appreciated, however, that the dental device 10 of the invention is not limited to any particular configuration or type of controls. Rather, the dental devices of the invention may be configured with any type of controls that are attached to the body of the dental device or that are remotely located away from the device, as desired.

As shown in FIG. 1, the dental device 10 may also include a focusing means configured to control the manner in which the light is dispersed from the dental device 10. In the present embodiment, the focusing means comprises a single lens 40 sized and configured so as to cover the light source 20 at the distal end 16 of the body 12 and to focus the light that is emitted from the light source 20.

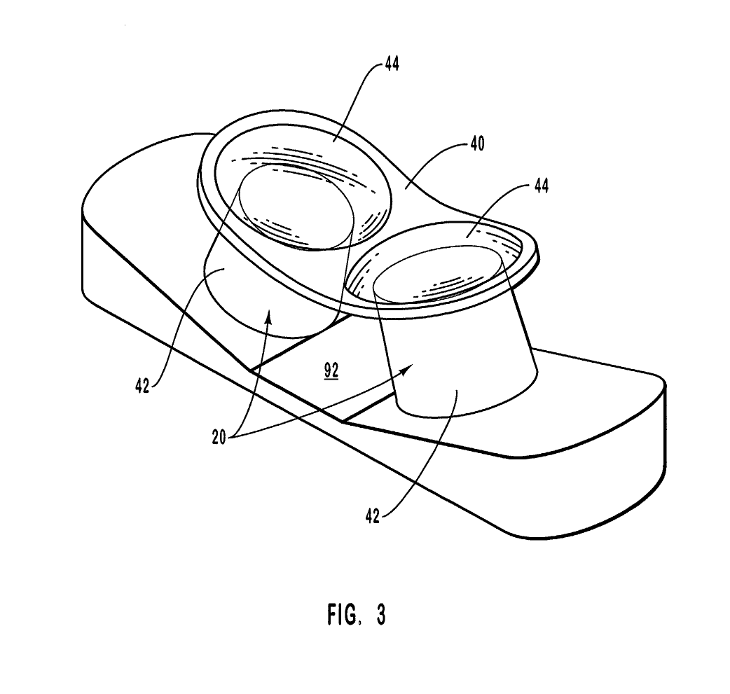

FIG. 3 illustrates a close-up perspective view of the lens 40 disposed above the two LEDs 42 of the light source 20. According to this embodiment, the lens 40 comprises a single integral lens configured to cover both of the LEDs 42. In embodiments including LED arrays or more LEDs, the lens 40 is correspondingly configured to cover the additional LEDs and LED arrays. In general, the shape and features of the lens 40 can also be configured to accommodate any desired need or preference. For instance, according to one embodiment the lens 40 is tinted red, yellow, orange, or another color to filter out undesired radiant energy produced by the LEDs. The shape and curvature of the lens 40 may also be customized to create a desired optical effect. According to one preferred embodiment, the lens 40 includes two hemispherical curvatures 44 concentrically aligned with the two different LEDs 42 for focusing the light emitted from the LEDs 42.

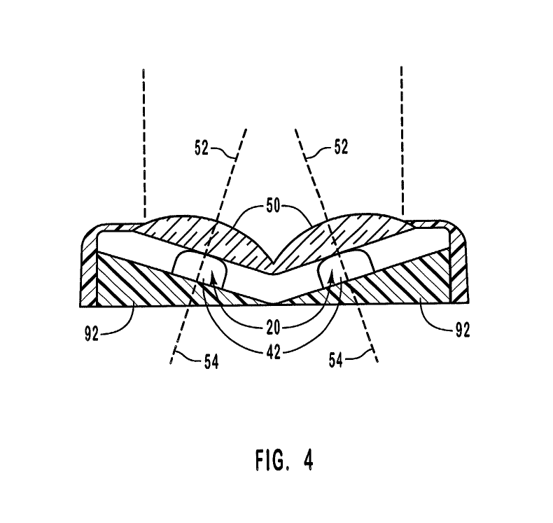

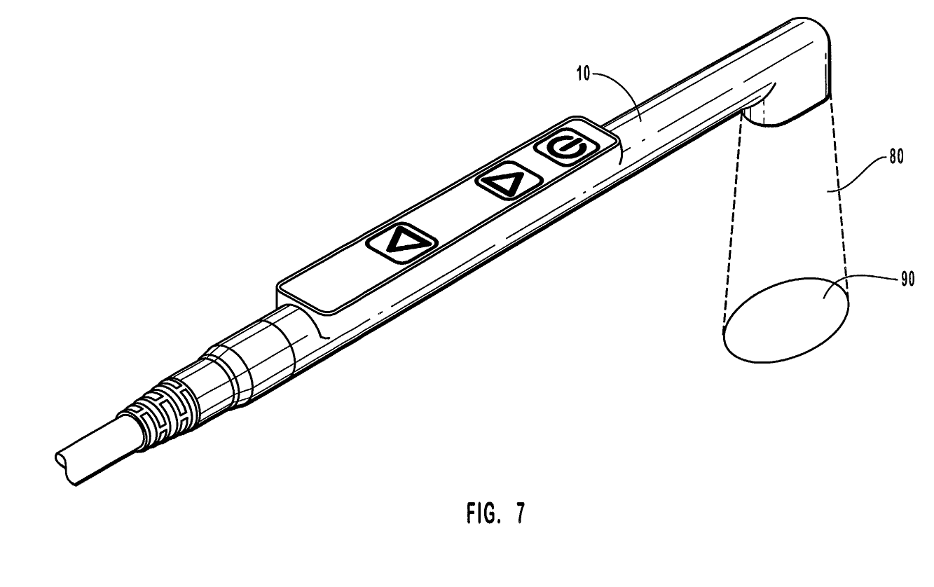

Focusing the light emitted from the LEDs 42 can also be accomplished with other focusing means. For instance, as shown in FIG. 4, the focusing means includes two independent hemispherical lenses 50 that are concentrically aligned with the LEDs 42. In other words, the central axis 52 of each hemispherical lens 50 is aligned with the central axis 54 of a different one of the LEDs 42. This causes the light emitted by the LEDs 42 to be refracted into a path of illumination having a desired footprint, as described below in more detail in reference to FIG. 7.

Generally, the desired optical effect of the focusing means is to reduce the angle of dispersion, of about 120° to about 140°, in which light is typically emitted from an LED. By reducing the angle of dispersion, it is possible to collimate the light so that the dental device 10 can efficiently operate within a greater range of distances from the desired application site. By way of example and not limitation, collimating the light enables the dental device 10 to irradiate a desired application site with substantially the same intensity of radiant energy at about 8 mm as at a distance of about 5 mm. It will be appreciated that this is an improvement over existing light curing devices incorporating LEDs that emit light with a wide angle of dispersion.

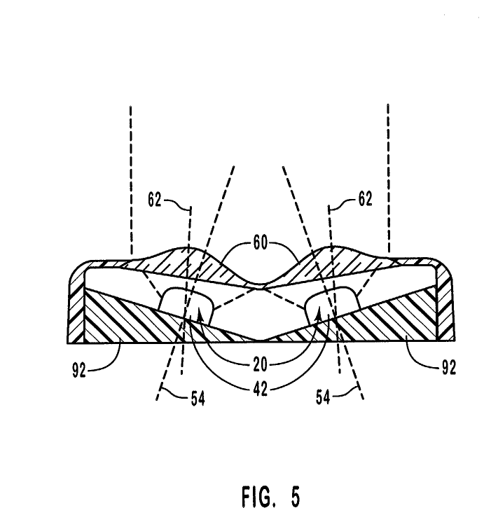

FIG. 5 illustrates another embodiment of the focusing means. As shown, the focusing means comprises two aspheric lenses 60 disposed above and concentrically misaligned with the two LEDs 42 of the light source 20. In other words, the central axis 62 of each aspheric lens 60 is askew to the central axis 54 of the LED 42 to which it corresponds. It has been found that by offsetting the respective axes 62, 54 of the aspheric lenses 60 and the LEDs 42 it is possible to create a desired collimating effect of the light emitted from the LEDs 42, as generally described above.

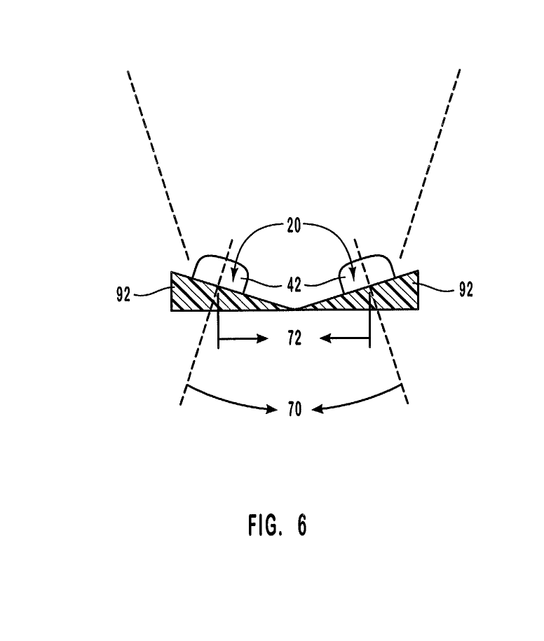

FIG. 6 illustrates yet another embodiment of the focusing means. As shown in the present embodiment, the focusing means does not include a lens. Rather, the focusing means comprises the offsetting configuration of the LEDs 42. In particular, according to the present embodiment, the focusing means for collimating the light into a desired path of illumination comprises offsetting the LEDs 42 at an angle 70 of between about 35° and 45° and at a distance 72 of between about 0.375 inches and about 0.75 inches, although other distances and angles can also be used to create a desired focusing effect.

According to the invention, focusing means for focusing the light emitted from the LEDs 42 can also include any combination of lenses and offsetting LED configurations, which are described above. In general, the desired effect of the focusing means is to concentrate the emitted light so that the dental device is more efficient and also for increasing the range of distances in which the dental device can be efficiently used to cure light-curable compounds during dental procedures.

FIG. 7 illustrates a top perspective view of the dental device of the invention emitting light within a path of illumination 80. According to the invention, the light emitted from the dental device is substantially collimated by the focusing means of the dental device 10, as generally described above, but not shown in FIG. 7. According to this embodiment the path of illumination 80 comprises a substantially elliptical footprint 90. The elliptical shape of the footprint 90 is useful because it corresponds with the substantially elliptical shape of the dental surfaces where the light is directed during dental restoration procedures, thereby increasing the overall efficiency of the dental device 10. It will be appreciated, however, according to other embodiments that are not shown, the footprint of the light source may also comprise other shapes, such as, for example, shapes generated by light sources that include three or more LEDs.

According to one embodiment, the dimensions of the elliptical footprint 90 fall within the range of about 8 mm to about 14 mm in width and within the range of about 10 mm and 16 mm in length at distances of between about 5 mm and about 8 mm from the light source. According to one preferred embodiment, the elliptical footprint is dimensioned about 10 mm in width and about 12 mm in length at distances between about 5 mm and about 8 mm away from the light source of the dental device 10.

As shown in FIGS. 3-6, the dental device may also include a heat sink 92 configured to dissipate heat generated by the light source 20. The LEDs 42 of the light source are preferably mounted directly onto the heat sink to increase the efficiency of the heat sink 92 through conduction. Accordingly, the heat sink is preferably composed of a conductive material, including, but not limited to materials comprising aluminum, copper, brass, steel, silver, gold, and combinations of the foregoing.

In summary, the dental devices of the invention include a light source and a focusing means configured to collimate and focus the light into a desired path of illumination. The focusing means may include, according to one embodiment, lenses disposed above the plurality of LEDs comprising the light source. The lenses may be placed into direct contact with the LEDs or spaced away from the LEDs. The lenses can also be fixedly connected or removably connected to the distal end of the dental device. For instance, in one embodiment, the lenses are fixedly connected to the distal end of the dental device with an adhesive, a mechanical coupling, chemical bonding or welding. In another embodiment, the lenses are removably connected to the distal end of the dental device with a friction fit or mechanical coupling such as a snap fit.

It will be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A dental device configured for curing light-curable compounds, comprising:
a body extending between a proximal end and a distal end;
a plurality of LED light sources disposed at the distal end of the body; and
a focusing means for collimating light emitted from a plurality of LED light sources.

2. A dental device as recited in claim 1, wherein each of the LED light sources comprises an LED.

3. A dental device as recited in claim 2, wherein the focusing means comprises a plurality of lenses.

4. A dental device as recited in claim 3, wherein the focusing means comprises a plurality of hemispheric lenses, and wherein each of the hemispheric lenses is concentrically aligned with a different one of the plurality of LEDs.

5. A dental device as recited in claim 1, wherein the focusing means comprises a plurality of aspheric lenses, and wherein each of the aspheric lenses is concentrically misaligned with a corresponding different one of the plurality of LEDs.

6. A dental device as recited in claim 1, wherein the focusing means is fixedly attached to the dental device.

7. A dental device as recited in claim 1, wherein the focusing means is removably attached to the dental device.

8. A dental device as recited in claim 1, wherein the focusing means comprises a material composition that includes plastic.

9. A dental device as recited in claim 1, wherein the focusing means comprises a material composition that includes glass.

10. A dental device as recited in claim 1, wherein the focusing means is configured to focus the light emitted from the light source into an elliptical footprint.

11. A dental device as recited in claim 10, wherein the desired footprint comprises a first dimension within the range of about 8 mm to about 14 mm and a second dimension within the range of about 10 mm to about 16 mm.

12. A dental device as recited in claim 1, wherein the light source and the focusing means are configured in size and shape for being placed within the mouth of a patient.

13. A dental device configured for curing light-curable compounds, comprising:
a body extending between a proximal end and a distal end;
two LEDs disposed at the distal end of the body; and
two lenses, each of said lenses disposed adjacent to a different one of said LEDs and configured to focus light emitted from said LEDs into a desired footprint.

14. A dental device as recited in claim 13, wherein each of said lenses is concentrically aligned with a different one of said LEDs.

15. A dental device as recited in claim 14, wherein each of said lenses comprises a hemispheric lens.

16. A dental device as recited in claim 15, wherein each of said hemispheric lenses is integrally connected to a single lens.

17. A dental device configured for curing light-curable compounds, comprising:
a body extending between a proximal end and a distal end;
two LEDs disposed at the distal end of the body, wherein the two LEDs are offset by a predetermined distance and a predetermined angle such that the light emitted from the two LEDs is channeled into a path of illumination having a desired elliptical footprint.

18. A dental device as recited in claim 17, further comprising two lenses disposed adjacent to a different one of the two LEDs and configured to focus light emitted from the two LEDs into the desired elliptical footprint.

19. A dental device as recited in claim 17, wherein the desired elliptical footprint comprises a first dimension within the range of about 8 mm to about 14 mm and a second dimension within the range of about 10 mm to about 16 mm at a distance of about 5 mm to about 8 mm away from the two LEDs.

20. A dental device as recited in claim 18, wherein the predetermined angle comprises an angle within the range of about 34 degrees and about 44 degrees and wherein the predetermined distance comprises a distance within the range of about 0.375 inches and about 0.75 inches.
